(19) United States
(12) Patent Application Publication
(10) Pub. No.: US 2014/0264167 A1
(43) Pub. Date: Sep. 18, 2014

(54) WATER VAPOR BARRIER COMPOSITION

(71) Applicant: MULTISORB TECHNOLOGIES, INC., Buffalo, NY (US)

(72) Inventors: Stanislav E. Solovyov, Getzville, NY (US); Samuel A. Incorvia, North Tonawanda, NY (US)

(21) Appl. No.: 13/832,219

(22) Filed: Mar. 15, 2013

(51) Int. Cl. B65D 81/26; B29D 22/00

(52) U.S. Cl. CPC B65D 81/264; B29D 22/003
USPC 252/194; 264/523

(57) ABSTRACT

The invention generally provides a moisture barrier article comprising a polymer matrix with water vapor permeability equal to or below 1 g mm/(m2 day) at 90% relative humidity difference and the intended temperature of use between 15° C. and 30° C., and moisture absorbing particles dispersed in the matrix in an essentially uniform manner, wherein the moisture absorbing particles have an average diameter of between 1 and 15 micrometers and wherein the article has an average wall thickness to mean particle diameter of at least 10:1.

### CROSS-REFERENCE TO RELATED APPLICATIONS

None.

### STATEMENT REGARDING FEDERALLY SPONSORED RESEARCH OR DEVELOPMENT

Not applicable.

### REFERENCE TO A “SEQUENCE LISTING”

Not applicable.

### FIELD OF THE INVENTION

This invention relates to the formation of a polymer composition that has barrier properties to the passing of water vapor through the composition. The composition comprises very fine particles of a water absorbent material, distributed in a polymer matrix.

### BACKGROUND OF THE INVENTION

Products such as food and medicines have long been sold in packages formed of materials that were intended to prevent deterioration of the food and medicine contained in the package. In the packaging art there have been packages formed of selected plastics that are better barriers to oxygen and/or water vapor transmission. Further there has been utilization of metallic and metalized films that prevent transmission of oxygen and water vapor.

There has been particular interest in the formation of packaging for medicines that will prevent moisture reaching the medicine. Such packages have often been produced with barrier materials to prevent the ingress of oxygen and water vapor. It has long been known to utilize sachets of a sorbent material added to packages to absorb water and oxygen. The difficulty with addition of containers of sorbent material to packages is that, while it is effective, the sachets or canisters containing the oxygen and water vapor sorbent may become mixed with the food and medicine and therefore may be accidentally consumed or, if the container breaks, contaminate the packaged product.

Many packaging applications require that the packaging remove components of the atmosphere within the package and/or prevent the ingress of undesirable atmospheric components from outside the package to the space within the package. Among these are packages designed to provide the contents with low moisture, and packages designed to provide the contents with atmospheres low in oxygen. Historically, materials have been provided within the packages to absorb the undesirable atmospheric components. Desiccants have been provided in the form of capsules, sachets, and other forms to absorb moisture; and oxygen-absorbers have been provided in similar forms to absorb oxygen. This type of protective measure combined with the package that acts as an effective barrier to the ingress of the undesirable atmospheric components provides reasonably good protection, but they are limited in their application. Materials that act as nearly absolute barriers to the ingress of oxygen and water, such as metal foil layers and inorganic glasses, are known but such materials are undesirable in some applications for a variety of reasons.

Utilization of metals and metallic foils in packaging is effective in providing a barrier, but limits the style of package available. Further, it limits the ability to visually observe with the material in the package. The utilization of clear or translucent polymers in packages allows the visual observation and identification of the material in the package. However, many polymeric packaging materials do not provide a long-term barrier to oxygen and water vapor permeation. Further those that provide a good barrier to oxygen permeation, such as polyvinyl alcohols and ethylene-vinyl alcohol copolymers are not resistant to water. Further, specialized plastics often require incorporation of several different material layers in a barrier structure to provide good barrier properties, may be expensive.

Metal containers may provide effective barriers, but plastics are more desirable in some applications for a variety of reasons, including low cost, lightweight, flexibility of manufacture, and the like. However, plastics, generally speaking, allow at least some of the undesirable atmospheric components to pass therethrough, and therefore are less effective as barriers to such transmission than metals. Heretofore, sorbents for absorbing the undesirable atmospheric components have been combined with plastic materials by applying layers of the sorbents to the inside of the plastic material. While these techniques provide some benefit, they do little to enhance long-term storage because, once saturated with the atmospheric component they are designed to inhibit, they become largely ineffective leaving only the unenhanced plastic material to act as a barrier.

There has been disclosed packaging materials having oxygen scavenging compositions or oxygen barrier materials present. Such materials also may contain water vapor absorbing materials. Typical of such materials are those in U.S. Pat. No. 5,744,056 to Venkateshwaren et al. and U.S. Pat. No. 5,820,956 to Hatakeyama. In this prior art the premoisturized water vapor sorbents are generally used to provide a moisture source for activation of oxygen scavenging compositions. Other mentioned applications of water sorbents in polymeric resins include films and container liners with entrained sorbents targeted for rapid water vapor absorption from the package headspace such as U.S. Pat. No. 7,005,459 to Hekal. These applications are described as a direct replacement of water absorbing sachets and canisters for controlling the package headspace and apparently do not contemplate improving the barrier function the composition.

Some packaged materials do not require significant oxygen barrier performance given the lack of sensitivity to oxygen and the life expectancy of the material in the packages. However, these materials may require significant protection from water vapor entering the package and deteriorating the product. It is not always practical or desirable to insert a separate water absorbing packet in a package, especially in multicavity blister packs used for individual medicine dose dispensing. Therefore, water vapor barrier packaging materials are needed.

Polymers providing a high barrier to water vapor permeation and suitable for long term packaging of pharmaceuticals are available (such as polychlorotrifluoroethylene—PCTFE), however they suffer from relatively poor processability, negative environmental impact during manufacturing and disposal, and high cost. It is desirable that conventional low-cost polymer packaging materials, such as polyethylene and polypropylene may be utilized in packages and to have these materials provided with a superior ability to prevent passage of water vapor into contact with the contents of the package. Therefore, there is a continuing need for a packaging material that will provide a low-cost and effective barrier to moisture entering a package. It is also often desirable that the packaging material be transparent or translucent, such that the packaged material may be observed.

### BRIEF DESCRIPTION OF THE INVENTION

The invention provides a moisture barrier article or a barrier layer comprising a polymer matrix with water vapor permeability equal to or below 1 g mm/(m² day) at 90% relative humidity difference and the intended temperature of use of between 15° C. and 30° C., and moisture absorbing particles dispersed in the matrix in an essentially uniform manner, wherein the moisture absorbing particles have an average diameter of between 1 and 15 micrometers and wherein the article or the barrier layer has an average wall thickness to mean particle diameter of at least 10:1 or higher.

### BRIEF DESCRIPTION OF THE SEVERAL VIEWS OF THE DRAWING

FIG. 1 is a schematic of the extrusion of strands of moisture barrier composition.

FIG. 2 demonstrates the sorbent capacity utilization profile across the container wall upon reaching the moisture diffusion time lag for the wall made from the composition.

FIG. 3 shows typical water vapor sorption isotherms for reversible and irreversible water vapor sorbents.

FIG. 4 demonstrates typical transient barrier performance of compositions with reversibly and irreversibly moisture absorbing particles.

FIG. 5 is a backscatter SEM image of micronized silica gel particle distribution in the extruded polypropylene sheet.

FIG. 6 is an optical micrograph of 4A molecular sieve particle distribution in the extruded polyethylene sheet.

### DETAILED DESCRIPTION OF THE INVENTION

The invention provides numerous advantages over prior art water vapor barrier compositions and methods of forming the prior art compositions. The water vapor barrier compositions of the invention provide materials that have a long lasting ability to prevent permeation of moisture. Further the compositions and articles of the invention are low in cost as lower-cost polymers and moisture absorbent may be utilized. The invention provides a rapid and effective method of uniformly disbursing small particle moisture absorbents in polymers. The uniform distribution of moisture absorbing particles in polymer makes the water absorbing composition of the invention much more effective in providing a barrier. The effectiveness of the invention barrier lowers cost as thinner barriers are required, therefore using less polymer and moisture absorbent. The above advantages and others will be apparent from the detailed description and drawing below.

It has been found that for purposes of providing an effective barrier, the techniques heretofore used to provide water-absorbing plastics should be modified. More specifically, we have found that by providing very finely divided desiccant particles and mixing the particles within the plastic formulation in a manner that substantially eliminates agglomeration and channeling between particles, an unexpectedly effective barrier material is obtained. The barrier properties are substantially improved over the same plastic material without the finely divided, substantially completely disbursed particles therein. One measure of barrier effectiveness is the time between placing the barrier material into service and the time that the water vapor from the external environment begins to enter into the interior space of the package. This time is commonly referred to as “lag time” or a time lag of the barrier. Its determination usually involves placing a dehumidified barrier sample into a controlled test chamber environment where a fixed RH gradient is maintained across the sample thickness (commonly used RH values are 0% and 90% at the opposite surfaces of the sample) at some fixed temperature relevant for the intended conditions of use. Before the expiration of the lag time, the barrier material provides a substantially complete barrier to the ingress of moisture. After the expiration of the lag time, the barrier continues to inhibit the ingress of water vapor but does not stop it altogether. At that time the accepted measure of barrier performance is its water vapor transmission rate (WVTR) expressed in g/(m² day).

Heretofore, plastic materials with agglomerated or non-substantially completely disbursed desiccants disposed within the polymer matrix not only had a relatively short lag time, but provided a substantially less effective barrier to the ingress of moisture after the expiration of the lag time. The very channels formed to enhance the effectiveness of the desiccant particles in the plastic reduce the effectiveness of the barrier once the desiccant particles were loaded with moisture.

The invention provides moisture barrier compositions for utilization in extruded and coextruded multilayer sheets and containers, particularly blow molded and injection blow molded containers. The sheets may be utilized in forming thermoformable containers, blister packs, bubble packs or other packaging requiring moisture barrier properties. The invention polymer sheet materials have a large amount of moisture absorbent present in the polymer (generally up to 30 vol. % as found out in the invention) at the same time providing for essentially complete separation between sorbent particles dispersed in the matrix. However, because the moisture absorbent material is of very fine particle size, the polymer remains formable, moldable and can also be at least partially transparent or translucent. The moisture absorbent particles preferably have a particle size of between 1 and 15 micrometers to provide good barrier properties and dispersion without particle aggregation in the polymer. The specific particle size distribution of moisture absorbent and its concentration in the polymer are directly related to the chemical nature of the polymer matrix, the desired thickness of the container wall, optical requirements and the desired duration of barrier protection. At the same time the maximum absorbent concentration in the resin is found to be limited by the requirements of uniform particle distribution and essentially complete separation of particles from each other. Otherwise, the desired level of barrier protection according to the invention may not be achieved despite potentially very high absorbent concentrations being present in a polymer. The water absorbent particles in the polymer article of the invention have substantially no agglomeration and substantially no contact between particles.

A barrier in accordance with this invention exhibits better performance than materials heretofore known, even after the lag time has elapsed because the fully saturated desiccant particles (without the hydrophilic surrounding layers) decrease the rate of flow of water vapor through the barrier by a significant amount (perhaps up to 30%-40%) compared with plastics with no particles embedded therein. The rate of flow is inhibited because of the desiccant particles creating a tortuous path for diffusing water molecules, similar to the known barrier effect of polymer nanocomposites filled with high aspect ratio nanoparticles but to a lesser extent.

In accordance with one aspect of the invention, the amount of sorbent carried by the resin can be substantially increased up to 30% to 50% by weight in some applications. Since the maximum particle loading without agglomeration is mostly dictated by volumetric fraction of particles distributed in the polymer (up to 30 vol. %), the ratio of the apparent particle density to the matrix polymer density determines the maximum weight fraction of the particles in a barrier composition. By way of example, a resin barrier without sorbents that has a lag time of about one day can be improved by the addition of a very finely divided essentially completely disbursed sorbent to a lag time of a year or more. Depending on the barrier article thickness, the barrier protection durations of up to 5-10 years are feasible for articles 1-3 mm thick. In some applications, this alone enhances the shelf life of the products shipped in the containers to an entirely satisfactory level.

In a general sense, there are two types of desiccant (moisture absorbing) materials that are contemplated for use in a barrier in accordance with this invention. A first type of desiccant material absorbs water vapor in a substantially irreversible fashion. That is, once absorbed the water vapor is not given up by the desiccant material even if exposed to an atmosphere having a relative humidity lower than the effective relative humidity of the plastic with the fully-absorbed desiccant material therein. This type of desiccant material provides relatively long lag times, but the effectiveness of the barrier to the ingress of moisture following the expiration of the lag time is somewhat less than barrier materials created with the second type of desiccant material that reversibly (or at least partially reversibly) absorbs moisture, but returns the moisture to the atmosphere when the relative humidity is decreased sufficiently. Such materials are characterized by the equilibrium water vapor sorption isotherms with essentially positive (possibly variable) slopes, i.e., the equilibrium absorbed water amount per unit weight of the sorbent material increases with the increasing RH of the environment as shown in FIG. 3.

Barrier materials in accordance with the invention made with this second type of moisture absorbent particles may provide a shorter lag time (actual times depend also on equilibrium absorption capacities of different sorbents at the condition of use), but their effectiveness as a barrier after the expiration of the time lag may be greater, especially if they possess a higher ultimate capacity to absorb water vapor. This second type of moisture absorbent particles may be useful in applications where a certain level of relative humidity within the container is tolerable, and it is desired to maintain the relative humidity within the container below that level for as long as possible. While the first type of barrier material may provide effectively zero relative humidity within the container for the duration of the time lag, the relative humidity will rapidly increase thereafter to a value that may exceed the acceptable limits within the container (in accordance with the passive water vapor transmission rate of the container wall material). The use of the reversible moisture absorbent particles provides a shorter time lag, but the effectiveness of the barrier material following the lag time is sufficient to maintain the relative humidity within the package at a low level for a longer time, at least as long as the lag time of the first materials (with equal equilibrium capacity), and therefore may provide a package that effectively maintains; for example, a 30% or lower relative humidity for a time greater than the lag time of the irreversibly-absorbing moisture absorbent particles barrier materials with equal ultimate absorption capacity. FIG. 4 illustrates the differences in barrier performance between moisture absorbing compositions with reversible and irreversible sorbent particles with equal equilibrium absorption capacities at 60% RH (the RH value is selected to represent a common condition of use).

The goals of utilizing very finely divided desiccant materials and providing essentially complete dispersion of the desiccant material in the plastic may be conflicting. Some desiccant materials, when very finely divided, tend to agglomerate and increase the difficulty of mixing the plastic material in a manner that ensures essentially complete dispersion of the desiccant. In accordance with this invention, a dispersion-enhancing agent such as mineral oil is added to the mixture to enhance dispersion. The dispersion-enhancing agent is selected so that it is substantially eliminated from the barrier material during processing. Light mineral oil is particularly suitable for this purpose because it tends to burn off or volatilize at the extrusion temperatures for the plastics, such as high density polyethylene, used in the barrier materials of this invention.

The mineral oil may be applied either to the desiccant material itself or preferably to the plastic pellets of which the desiccant material is mixed; thereby providing for introduction into an extruder, such as a twin screw extruder, plastic pellets coated with mineral oil and having a thin layer of finely divided desiccant material applied to the surface thereof. Such desiccant-coated pellets, when passed through a twin screw extruder, provide the relatively high loading levels of very finely divided desiccant material disbursed substantially completely throughout the plastic material with little agglomeration or channeling. Alternatively, depending on the nature of the desiccant material, the finely divided desiccant material itself can be coated with a dispersion-enhancing agent such as mineral oil, prior to mixing with the plastic pellets.

In accordance with another aspect with this invention, it is desirable to decrease the tendency of the plastic material to form cavities or spaces surrounding the finely divided desiccant during the molding process. The presence of such cavities is undesirable because they provide a pathway for water to move freely through the plastic, thus decreasing the effectiveness of the material as a barrier. In accordance with the invention, molding processes that allow the molded article to contract during cooling minimize the formation of cavities around the desiccant particles. In particular, blow molding is more effective than injection molding in producing barrier material substantially free from cavitation. Predrying of the desiccant powder prior to compounding is generally required to eliminate formation of voids in the composition during compounding due to desorption and expansion of water vapor at commonly used polymer processing temperatures.

The selection of an appropriate desiccant material for an enhanced barrier layer in accordance with this invention depends on a number of factors. Where the longest possible lag time is desired, materials such as molecular sieves (synthetic zeolites) and irreversible chemical sorbents like calcium oxide can be used. Where shorter lag times but enhanced performance of the barrier material following the expiration of the lag time is desirable, reversibly-absorbing materials such as micronized silica gel may be employed. Certain desiccants are available in finely divided sizes, while other desiccant materials must be milled or otherwise reduced in size to produce the finely divided particles used in accordance with this invention. For example, silica gel is normally available in relatively large millimeter scale particle sizes, but can be milled for use in barrier compositions in accordance with this invention.

Briefly stated and in accordance with one aspect of the present invention, an enhanced resin barrier material comprises a layer of plastic material loaded with a finely divided sorbent material such as a desiccant substantially completely disbursed in the plastic material without significant agglomeration or channeling.

In accordance with another aspect of this invention, enhanced barrier material comprises a layer of high density polyethylene, low density polyethylene, or polypropylene having at least a 30 weight percent of finely divided silica gel substantially completely disbursed therein with essentially no agglomeration or channeling.

In accordance with another aspect of this invention, a method for making an enhanced resin barrier material comprises the steps of providing a resin material; providing a finely divided sorbent material; providing a dispersion-enhancing material; mixing the resin material, sorbent material, and dispersion-enhancing material; extruding the mixture and molding a container from the extruded material.

In accordance with another aspect of this invention, a method for making a container from an enhanced resin barrier material comprises molding the material by blow molding the mixture of resin, sorbent and dispersion-enhancing material.

In accordance with another aspect of this invention, mixing the resin, sorbent, and dispersion-enhancing material comprises mixing in a suitable single or twin screw extruder.

In accordance with another aspect of the invention, the method for manufacturing an enhanced resin barrier material comprises separately introducing the resin and the finely divided sorbent into spaced apart inlets to a screw extruder.

Once the desiccant particles become fully saturated with water, they act in a manner similar to nano-particles to block the transport of water through the resin barrier layer. Water molecules are not significantly mobile within saturated silica gel, for example. This is due in part at least to the fact that there is a physical phase change and the water bound to the silica gel as well as condensed in its pores is mostly immobilized by the gel.

The particles should be as small as possible, but in any event they must be sufficiently small so that they can be substantially completely disbursed in the plastic layer. The goal is to have a relatively large number of particles so that the statistical probability of a water molecule encountering a particle during diffusion across the barrier later is high, preferably equal to 1, meaning 100% chance of encountering at least one particle. This is achieved by selecting the mean sorbent particle size to be at least 10 times smaller than the effective thickness of the disclosed barrier article or the barrier layer.

The invention provides moisture barrier compositions for utilization in sheets and containers, particularly blow molded containers. The single layer and coextruded multilayer sheets may be utilized in forming thermoformable blister packs, bubble packs or other packaging requiring moisture barrier properties. The invention polymer sheet materials have a large amount of moisture absorbent present in the polymer. However, because the moisture absorbent material is of very fine particle size, the polymer remains formable, moldable and also transparent or translucent. The moisture absorbent particles preferably have a particle size of between 1 and 15 μm to provide good barrier properties and dispersion without particle aggregation in the polymer. A preferred particle size is an average diameter size of 2-10 micrometers and a mean diameter between 3 and 5 micrometers for good transparency and good moisture absorption.

In FIG. 1 is illustrated the formation of strands of moisture absorbent polymer. The polymer pellets are placed into the extruder 10 at throat feed port 12. The pellets have been combined with a light oil such as mineral oil prior to entry into the extruder. The polymer and mineral oil are mixed and become molten as they move to area 14 of the extruder where the moisture absorbent particles are added at side feed 15. The moisture absorbent material is then subjected to further mixing and heating and is extruded as strand 17 from nozzle 16, cooled by fan 18, and cut into strand pellets 22 by cutter 21. The strand pellets are collected in container 26.

While illustrated with cutting of the pellets into a container 26 there are other treatments of the pellet that are possible. The cooling of pellets in a water bath or by passage through an air-cooled tunnel would also be possible and desirable for high speed processes. Water bath cooling was found to be acceptable only for reversible sorbents and if the produced pellets are predried or otherwise dehumidified before further processing.

The strand pellets of moisture absorbent composition, resulting from the extrusion process, are by known techniques heated to a molten state and then formed into a useful article. The molten polymer may be formed into a sheet by casting onto a substrate, such as a rotating drum, with subsequent removal from the substrate after cooling. Further, the material could be cast onto a substrate where it forms one layer of a multilayer material that may be utilized in a container. If formed into a sheet the moisture absorbing material may be utilized in a bag or bubble pack for pill dispensing or for storage of foods, medicines, or moisture sensitive chemicals. The moisture absorbing strand pellet material recovered from the extrusion process also could be heated to a molten condition and utilized in the known injection molding or die press molding processes. A preferred use for the moisture absorbing material of the invention is blow molding, as this type of molding is believed to form polymer containers substantially free of voids.

The polymer utilized for the moisture absorbent material may be any suitable polymer or resin utilized in forming sheets or containers. Typical of such materials are polyesters and copolymers with polyesters and acrylics such as copolymers with butadiene and styrene. The preferred materials for producing a barrier composition are high water vapor barrier resins, characterized by low moisture uptake and slow rates of moisture diffusion in them. Such materials are often characterized by their hydrophobic nature and low polarity of polymer chain segments and/or strong attractive interactions between such segments, combined with negligible levels of swelling upon moisture uptake, that serve to prevent efficient water vapor transport in them. Preferred materials have been found to be polychlortrifluoroethylene (PCTFE) and polyolefins such as polypropylene, polyethylene, cyclic olefin copolymers, and mixtures thereof as they are thermoplastic, moldable, and low in cost. An optimum material has been found to be high density polyethylene as it is a non-polar high crystallinity hydrophobic polyolefin with very low water vapor permeability readily moldable at blow molding temperatures, low in cost, and mixes well with very fine particles such as a silica gel of the size range of the invention.

The oil for mixing with the pellets of polymer prior to entry into the extruder may be any suitable light oil that will vaporize at the time the resin is molten and will not leave undesirable residues in the moisture absorbing polymer. A preferred light oil is mineral oil as it is low in cost and efficiently lubricates the raw polymer pellets and the very fine moisture absorbent particles so that they mix uniformly. While the oil is often mixed with the pellets prior to insertion into the extruder, it is preferable that the oil could be mixed with the fine moisture absorbent particles prior to placing the moisture absorbent particles into the extruder. The effective mixing of sorbent particles with oil is believed to help prevent sorbent particle agglomeration during melt compounding stage.

Any suitable amount of light oil may be utilized in the invention. A suitable amount is between 0.1 and 2% by weight of the polymer matrix material. A preferred amount is between 0.2 and 0.3% by weight of the matrix polymer for uniform mixing of the moisture absorbent particles in the polymer matrix and to not extend extrusion time for the oil to be removed by vaporizing.

Lag times for moisture barrier materials of the invention may be quite long. A one millimeter thick polypropylene sheet loaded with 40% by weight of 10 micrometer average size silica gel will have a lag time of 6-10 years at a relative humidity of 50% or below. The barrier function is illustrated in FIG. 2 where the * represents unused capacity and + illustrates used (equilibrium saturated) capacity. The unused fraction of the absorbent reduces the diffusive flow of water even after the lag time when water vapor starts to reach the inside of the container.

The permeability of gas or vapor in a material is a measure of steady state mass transport rate of vapor across the unit thickness of a material under specified vapor pressure difference across the thickness. The permeability (P) is generally understood as the product of solubility (S) of water vapor in the polymer (equilibrium thermodynamic property) and diffusivity (D) of water vapor in the polymer (a kinetic measure of mobility of vapor molecules in the matrix):

$$S = \frac{mol}{{m}^{3} Pa} and D = \frac{{m}^{2}}{s} , - \\ P = DS = \frac{mol m}{{m}^{2} sPa}$$

High permeability of the matrix, the presence of voids and cracks, particle-to-particle contact and agglomeration all facilitate vapor access to the sorbent particles. In the same time, these properties reduce effectiveness of the “active” sorbent-loaded barrier. Heretofore, plastic materials with agglomerated or non-substantially completely disbursed moisture absorbent particles disposed within the polymer matrix not only had a relatively short lag time, but provided a substantially less effective barrier to the ingress of moisture after the expiration of the lag time. Within the scope of the invention, the particles are considered to be agglomerated if two or more particles embedded in the polymer are directly touching each other. However, the presence of 2-5 particle agglomerates was found to not significantly compromise the barrier function of the disclosed barrier composition if the mean size of the agglomerates falls within the recommended article thickness to particle size ratio (10:1 or higher). Depending on the desired barrier article thickness and the preferred initial particle size distribution of sorbent particles within 1-15 micron, a few agglomerates up to 20-40 micron in size may be present in the composition without significantly affecting its barrier performance. It is the preferred embodiment that no more than 2% of total weight of the sorbent particles in the composition to be present in the agglomerated form and no single agglomerate exceeded 50 micron in size to maintain the barrier performance.

The particles in close proximity to each other in the matrix but not directly touching may create an effect described in prior art as channeling. Water vapor channeling in resins is enhanced by the incompatibility between the matrix polymer and the particles (responsible for forming interfaces and pores in the matrix), the presence of hydrophilic polymer phase mostly associated with the particles and formation of entrained assemblies of particles due to poor mixing (both directly responsible for the channeling effect). The very channels provided to enhance the effectiveness of the moisture absorbent particles in the plastic reduce the effectiveness of the barrier. Low water vapor permeability polymers loaded with distributed and well separated fine sorbent particles described in the invention but without the presence of discontinuous hydrophilic resin phase(s) provide the desirable high barrier function and the long duration of barrier protection.

A barrier in accordance with this invention exhibits better performance than materials heretofore known, even after the lag time has elapsed because the residual absorption capacity of the sorbent particles slows down the increase in the RH inside a package and the fully saturated moisture absorbent particles (without the hydrophilic surrounding layers) decrease the rate of water vapor permeation through the barrier by a significant amount (several orders of magnitude barrier improvement as well as nearly absolute barrier protection are possible during the time lag depending on the barrier thickness) compared with plastics with no absorbent particles embedded therein.

Any suitable moisture absorbing particle material may be utilized in the invention. Typical of reversible absorbents are such materials as diatomaceous earth, zeolites, molecular sieves, talc, a calcined vermiculite, activated carbon, graphite, bentonite clay, and kaolin clay. In addition to mineral oils, suitable particle compatibilizing and dispersion aiding materials are covalently bonded organic titanates, and zirconates, serving to reduce incompatibility between the particles and the matrix polymer without introducing water permeable hydrophilic interfaces. A reversible preferred sorbent material is micronized silica gel, as it may be obtained in accurately measured fine particles as needed for the invention, mixes well with the preferred high density polyethylene, and it absorbs water reversibly. All the above materials are considered to be the type of moisture absorbing material that reversibly absorb moisture, but at certain lower relative humidities will give up the moisture.

Any thickness of material that provides suitable water vapor barrier and water vapor absorption may be used. A thicker wall may use less water absorber (smaller fraction in the composition) to reach the same barrier property. There is an exponential improvement in transient water vapor barrier properties by increasing wall thickness with the same fraction of loaded water vapor absorber (compared to inverse linear improvement with thickness observed for passive barrier materials without the sorbent).

The preferred silica gel particles of the invention are porous, but with pores of very small size of generally less than 20 angstroms such that resin will not enter, but water may be adsorbed in the pores. Silica gel particles are amorphous solids with very large surface area per unit weight and they do not expand as a result of water adsorption, unlike calcium oxide. The small size and lack of particle swelling largely prevents stress formation in the matrix (which often results in physical aging and crack formation in the polymer) that would allow water vapor to move through the composite material faster. Materials of the prior art with larger particles are theorized to allow efficient passage of water vapor through the particles themselves and potentially through porous areas opening around swelling large particles. Even if the particles do not swell it is difficult to disperse large particles in a polymer and not have voids. The suitable clay materials, as well as natural and synthetic 3A, 4A, 13X zeolites, are crystalline solids that have pores of about 3-10 angstrom in diameter and are also suitable for absorbing water vapor without swelling.

Any suitable amount of the moisture absorbent particle may be utilized in the invention. If has been found to be possible to load the fine moisture absorbent particles in an amount of up to about 40% of the total volume of the moisture absorbing composition. A preferred range for the preferred silica gel particle has been found to be between about 10 and 30 percent of the total volume of the composition for absorption of a high amount of moisture while retaining the transparent or translucent properties of the polymer and providing for particle separation. It is noted that the resin does not enter the sorbent particle pores due to large molecular weight and poor mobility of individual polymer chains. When using micronized silica gel, 25% by volume is equal to about 40% by weight of a polypropylene composite material.

The average particle size of the moisture absorbing particles suitable for use in the invention has been found to be between 1 and 15 micrometers. A preferred range has been found to be an average particle size of between 3 and 10 for an effective product distribution when mixed with high density polyethylene and for effective absorbing of water. The loading of very small absorbent particles in high volume amounts also increases the likelihood of water vapor contacting a particle and being absorbed as it passes through the polymer.

While the moisture absorbing polymeric material of the invention has been described in a preferred form as only containing a moisture absorbent it is also possible that the moisture absorbing composition could contain other sorbents such as those suitable for absorbing oxygen or acid vapors. Oxygen absorbent materials include materials such as iron, copper, zinc, and aluminum in combination with electrolytes and acidifying agents, such as alkaline metal chlorides, sulfates, nitrates, carbonates and sulfites, as well organic polymer based oxygen absorbers compatible with the matrix or forming part of the matrix polymer. Materials such as graphite and activated carbon will absorb acids. It is also possible that other materials may be present in the composition such as compatibilizing agents, inactive fillers including nanoparticles, bactericides, fungicides, and colorants.

### EXAMPLES

### Example 1

30 wt. % of micronized (average particle size 1-10 micrometer) silica gel are compounded with extrusion grade polypropylene in a twin-screw extruder and subsequently pelletized. 1 wt. % mineral oil was added to and mixed with pre-dried silica gel powder before compounding. The FIG. 5 (backscatter SEM image of 0.5 mm thick extruded sheet made from the compound) demonstrates uniform silica gel particle distribution with essentially separated particles in 1-10 micrometer size range. In FIG. 5 the silica shows as bright powder particles at 2 micrometer depth. No agglomeration is indicated.

### Example 2

Several sizes of containers are produced from the composite sheet of the Example 1 utilizing thermoforming process (vacuum forming into a female mold and vacuum forming with plug assist). The containers range from multicavity blister packs with individual cavity diameter of 10 mm and 4 mm depth to rectangular containers with approximate dimensions of 50×50×30 mm. The resulting wall thickness of the containers is within 0.15-0.4 mm. The water vapor transmission rate of individual containers was subsequently measured at 23° C. and 90% RH to validate the barrier performance. More than 3 consecutive months of zero water vapor permeation rate were observed for the thermoformed samples while the capacity based calculations showed that this level of performance should last for at least 12-18 months or more followed by gradual RH increase in the blister cavity.

### Example 3

40 wt. % of 4A molecular sieve (average particle size 3-15 micrometer) are compounded with extrusion grade low density polyethylene in a twin-screw extruder and subsequently pelletized. 1 wt. % mineral oil was added to and mixed with polyethylene pellets before compounding. The FIG. 6 (optical image of 0.5 mm thick extruded sheet made from the compound) demonstrates uniform particle distribution with essentially separated particles in 3-15 micrometer size range. In FIG. 6 the round dark images are the molecular sieve particles. No agglomeration is shown.

1. A moisture barrier article comprising a polymer matrix with water vapor permeability equal to or below 1 g mm/(m² day) at 90% relative humidity difference and the intended temperature of use between 15° C. and 30° C., and moisture absorbing particles dispersed in the matrix in an essentially uniform manner, wherein the moisture absorbing particles have an average diameter of between 1 and 15 micrometers and wherein the article has an average wall thickness to mean particle diameter of at least 10:1.

2. The moisture barrier article of claim 1, wherein said moisture absorbing particles comprise between 1 and 40 percent by weight of the moisture barrier composition.

3. The moisture barrier article of claim 1, wherein the moisture absorbing particles are selected from the physical water absorbers consisting of silica gel, molecular sieve, natural or synthetic zeolite, carbon, clay, or any combination of thereof.

4. The moisture barrier article of claim 1, wherein the moisture absorbing particles have an average diameter of between 2 and 10 micrometers and a mean diameter between 4 and 5 micrometers.

5. The moisture barrier article of claim 1, wherein said polymer comprises polyolefin, polyolefin copolymer, or polyolefin blend.

6. The moisture barrier article of claim 1, wherein said polymer matrix comprises high density polyethylene.

7. The moisture barrier article of claim 1, wherein said moisture barrier composition is substantially free of surfactants and hydrophilic resin additives.

8. The barrier article of claim 1, wherein the article has an average wall thickness to a mean particle diameter ratio of 50:1 or higher.

9. The barrier article of claim 1 wherein the article is a sheet and the moisture absorbing particles comprise between 10 and 30 percent of the total sheet weight.

10. The barrier article of claim 1 wherein the moisture absorbing particles comprise silica gel.

11. The barrier article of claim 1 wherein the moisture absorbing particles comprise natural or synthetic zeolites.

12. The barrier article of claim 1 wherein the moisture absorbing particles are substantially without interparticle contact.

13. The moisture barrier of claim 1 wherein the article has substantially no agglomeration of the moisture absorbing particles.

14. The moisture barrier of claim 1 wherein the article less than 2 weight % of particles are agglomerated and the maximum size of the agglomerate does not exceed 50 micrometers.

15. The method of forming a moisture barrier composition comprising feeding polymer pellets into an extruder, passing the polymer through a heating portion of the extruder, feeding into the extruder moisture absorbing particles of an average diameter of between 1 and 15 micrometers, adding a light oil to the extruder either with the pellets or the particles, melting and mixing said polymer pellets, oil and moisture absorbing particles in the extruder, and extruding the molten polymer matrix with uniformly dispersed moisture absorbing particles as a strand, pelletizing the strand, and cooling the strand pellets to recover the moisture barrier composition.

16. The method of claim 15, wherein said polymer comprises a polyolefin polymer.

17. The method of claim 15, comprising melting the strand pellets of the moisture barrier composition and feeding the melted particles into a blow molding chamber to form a container.

18. The method of claim 15, wherein said polymer comprises high-density polyethylene.

19. The method of claim 15, wherein the moisture absorbing material is blanketed in dry nitrogen, to maintain maximum moisture absorption capacity prior to feeding into the extruder.

20. The method of claim 15, wherein the moisture absorbent particles have an average particle size of between 2 and 10 micrometers.

21. The method of claim 15, wherein said moisture absorbing particles comprise silica gel.

22. The method of claim 15, wherein the extruder is a co-rotating twin screw extruder.

23. The method of claim 15, wherein said moisture absorbing particles are present in an amount of up to 40 percent by weight of the strand pellets.

24. The method of claim 15, wherein the oil is mixed with the polymer pellets prior to addition of the pellets to the extruder.

25. The method of claim 15 wherein the strand pellets comprise between 10 and 30 percent of the total sheet weight.

26. The barrier method of claim 15 wherein the moisture absorbing particles are substantially without interparticle contact in the pellets.

27. The moisture barrier of claim 15 wherein the strand pellets have substantially no agglomeration of moisture absorbing particles.

28. The method of claim 15 wherein the pellets less than 2 weight % of particles are agglomerated and the maximum size of the agglomerate does not exceed 50 micrometers.

29. The method of claim 15 wherein the moisture absorbing particles comprise natural or synthetic zeolites.

30. Polymer pellets comprising polymer and moisture absorbing particles uniformly dispensed in the polymer wherein the absorbent particles have a particle size of between 2 and 10 micrometers, comprise between 10 and 30 percent by weight of the total pellets weight and the moisture absorbent particles are substantially without interparticle contact.

31. The pellets of claim 30 wherein the moisture absorbent is selected from at least one member of the group consisting of silica gel, synthetic zeolites, and natural zeolites.

32. The pellets of claim 30 wherein the pellets have substantially no agglomeration of the moisture absorbing particles.
